(19) United States
(12) Patent Application Publication
(10) Pub. No.: US 2017/0283119 A1
(43) Pub. Date: Oct. 5, 2017

(54) DRAIN SPOUT FOR SANITARY TRAILERS

(71) Applicant: Polar Tank Trailer, LLC, Holdingford, MN (US)

(72) Inventors: Scott J. Caird, Rice, MN (US); Aaron R. Johnson, Clear Lake, MN (US); Adrian J. Nistler, Clearwater, MN (US); Gerald M. Pickarski, Little Falls, MN (US); Jeremiah J. Poepke, Becker, MN (US); Derek J. Schaefer, Holdingford, MN (US); Peter M. Weis, St. Cloud, MN (US); Richard J. Wimmer, Swanville, MN (US)

(21) Appl. No.: 15/089,641

(22) Filed: Apr. 4, 2016

(51) Int. Cl. B65D 25/48; B60P 3/22

(52) U.S. Cl. CPC B65D 25/48; B60P 3/224

(57) ABSTRACT

The invention provides an improved drain spout that is attached to tanks for draining the liquid contained in the tank. More specifically, a drain spout that is cast as a unitary structure and comprising a smoothed radiused transition from a flanged sump to a flow pipe is provided.

### CROSS-REFERENCE TO RELATED APPLICATIONS

None.

### BACKGROUND OF THE INVENTION

### Field of the Invention

The invention relates to drain spouts attached to tanks for draining the liquid contained in the tank. More specifically, a drain spout that is cast as a unitary structure and comprising a smoothed radiused transition from a flanged sump to a flow pipe is provided.

### Description of the Related Art

Sanitary tank trailers have a drain spout attached to a rear bottom portion of the tank, typically attached on the rear head section of the tank trailer. Known drain spouts are manufactured by welding a semi-spherical cup to a previously cut pipe. This connection method causes warping and does not facilitate full draining of the tank's contents.

In addition, the welding attachment of the known drain spout to the tank surface results in further warping and distortion. Thus, an improved design is needed.

The figures and the detailed description which follow more particularly exemplify these and other embodiments of the invention.

### BRIEF DESCRIPTION OF THE DRAWINGS

The invention may be more completely understood in consideration of the following detailed description of various embodiments of the invention in connection with the accompanying drawings, which are as follows.

FIG. 1 is a side view of a prior art device;

FIG. 2 is a side view of one embodiment of the present invention;

FIG. 3 is a front cross-sectional view of one embodiment of the present invention along the line A-A of FIG. 2;

FIG. 4 is a top view of one embodiment of the present invention;

FIG. 5 is a side cross-sectional view of one embodiment of the present invention along the line B-B of FIG. 4;

FIG. 6 is a front view of one embodiment of the present invention; and

FIG. 7 is a rear view of one embodiment of the present invention; and

FIG. 8 is a schematic diagram of one embodiment of the present invention installed on a tanker trailer.

### DETAILED DESCRIPTION OF THE INVENTION, INCLUDING THE BEST MODE

While the invention is amenable to various modifications and alternative forms, specifics thereof are shown by way of example in the drawings and described in detail herein. It should be understood, however, that the intention is not to limit the invention to the particular embodiments described. On the contrary, the intention is to cover all modifications, equivalents, and alternatives falling within the spirit and scope of the invention.

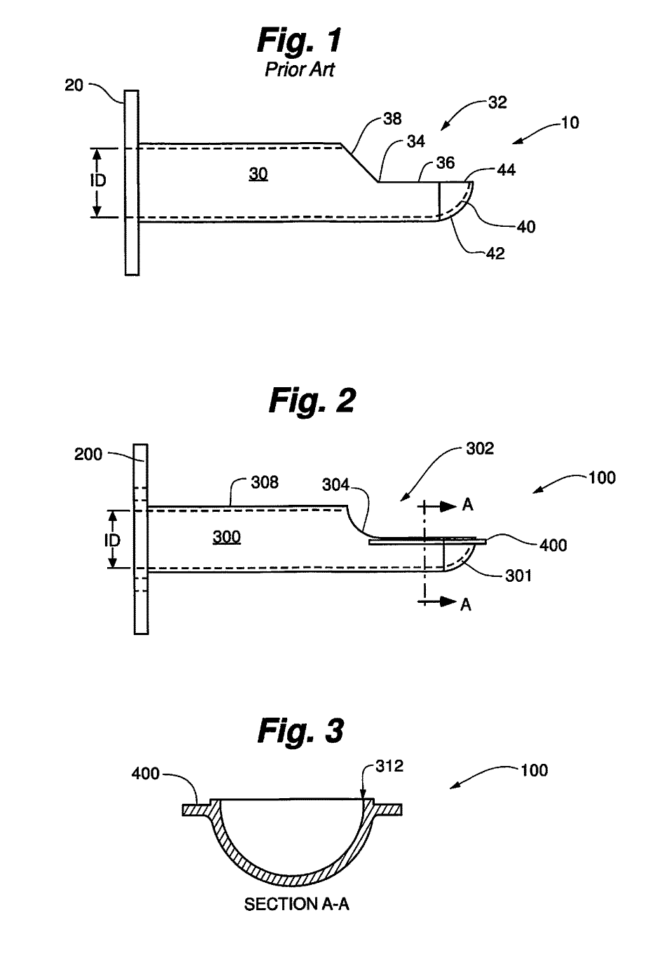

FIG. 1 illustrates a prior art drain spout device 10 that is welded to the bottom rear surface of a tank, typically a sanitary tank and is used to empty the tank's contents. The prior art device consists of three primary elements: a connection base 20, a flow pipe 30 connected with the connection base 20, and a proximal cup 40 that is fixedly attached to the flow pipe 30. The flow pipe 30 comprises an internal diameter, illustrated by ID bounded by the dashed lines, and a cutaway portion 32 immediately adjacent to the attached proximal cup 40. Cutaway portion 32 is oriented to provide an upper region of the flow pipe 30 that is open and comprises a non-radiused corner 34 connecting an open lower surface 36 with an open angled surface 38.

Proximal cup 40 comprises a radiused end 42 and an open upper surface 44 that is coincident with the open lower surface 23 of flow pipe 30, thereby creating a generally flat surface comprising open lower surface 36 of flow pipe 30 and open upper surface 44 of proximal cup 40. Proximal cup 40 has an internal space bounded by dashed lines as illustrated. The internal space for proximal cup 40 must match with the lower boundary of the internal space of the flow pipe 30, as illustrated by dashed lines.

The initial difficulty with this known structure is that the connection between proximal cup 40 and flow pipe 30 is achieved by welding and is difficult to obtain a smoothed internal surface. This, in turn, results in a turbulent flow of material within the prior art device that inhibits flow speed.

Further, the design must be welded to the tank and, in so doing, often results in warping and further turbulence and the resulting fluid flow difficulties.

Finally, the non-radiusing of the corner 34 of flow pipe 30 must be fit against a radiused section of the tank, leaving a gap in at least the non-radiused corner 34 region between the device 10 and the tank.

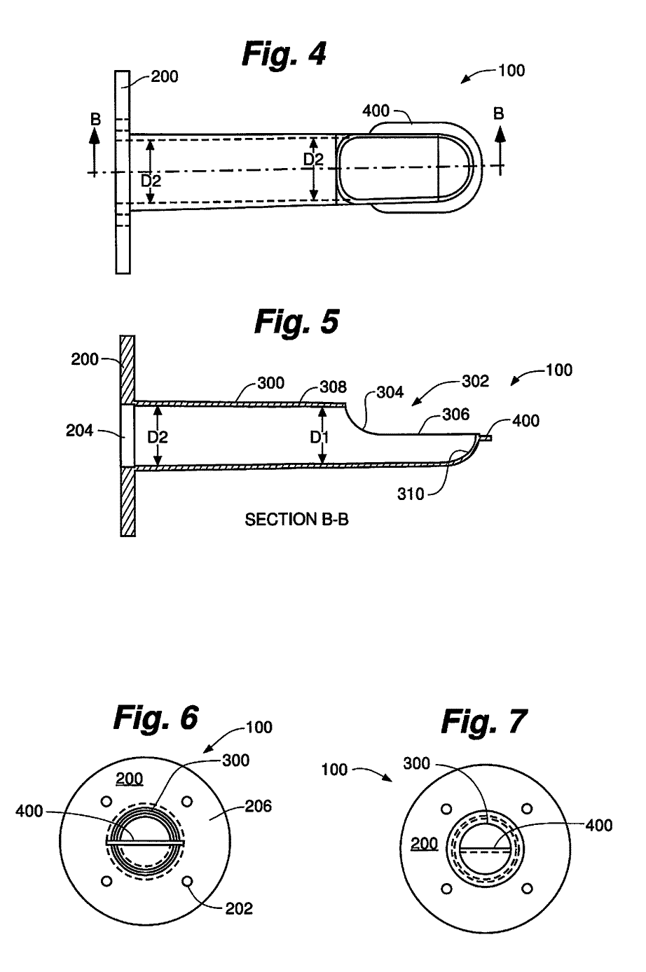

Turning now to FIGS. 2-8, the inventive embodiments will be described. Thus, an improved drain spout 100 is illustrated and comprises three primary elements: a distal connection base 200, a flow pipe 300 and a proximal flange 400. In one embodiment, the distal connection base 200 and flow pipe 300 are provided as a casted unitary structure, without break therebetween and without need, therefore, for welding connection as in the known spout. In a particularly preferred embodiment, proximal flange 400 is also part of the casted whole, so that the flange 400 also does not require a welded attachment. The unitary casting embodiments represent a significant improvement over the art in terms of provision of a smoothed internal surface throughout the drain spout and the resulting non-turbulent fluid flow therethrough.

Distal connection base 200 comprises a generally circular profile with a plurality of connection holes 302 therethrough. Four holes 202 are illustrated, though the number can vary as the skilled artisan will readily understand. A central circular aperture 204 is provided with an internal diameter. Distal connection base 200 comprises a proximal face 206 and a distal face 208.

Flow pipe 300 is an extension of the distal connection base 200 and comprises a generally circular external surface profile and a circular internal surface and comprising a radiused cup 301 at proximal end of sump 302. The upper surface of the flow pipe 300 is eliminated at the proximal end P, resulting in a proximal elongated sump 302 that is open and capable of receiving fluid. The distal end of the sump 302 comprises a smoothed radiused transition 304 from a reduced height upper surface 306 to the external surface 308 of the flow pipe 300. As best seen in FIG. 5, the structure of sump 302 further comprises a smoothed radiused proximal internal surface 310 to ensure that fluid flow entering the sump 302 is directed distally as the incoming fluid encounters the radiused proximal internal surface 310 of sump 302.

Flow pipe 300 may also comprise a gradual and smoothed increase in internal diameter working distally along the pipe 300 from sump 302 toward the aperture 204 of connection base 200. Thus, in this embodiment and as shown D1 is less than D2. This gradient enhances the flow of fluid received by the cutaway section by creating an ever-increasing volume that may be pumped out as well as creating a slight downhill grade for the fluid flow as it progresses distally through the internal surface of flow pipe 300 to help ensure that no fluid is retained therein.

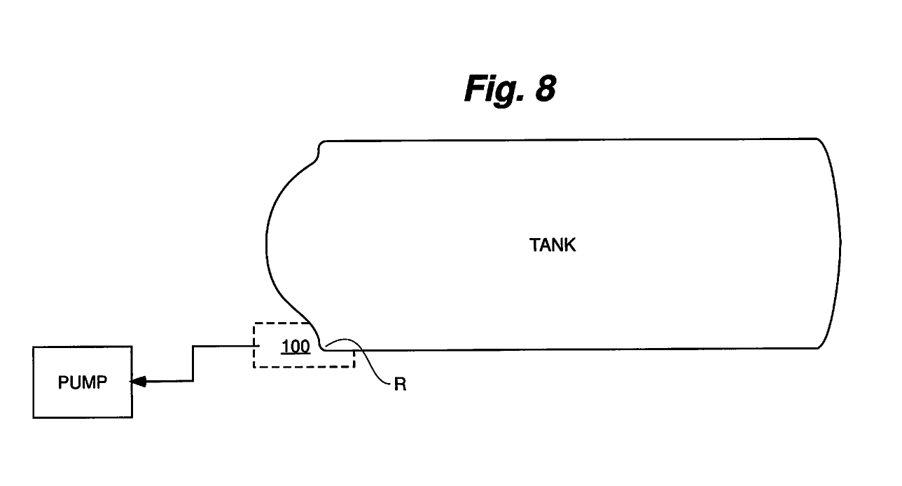

The significance and utility of the radiused transition 304 of flow pipe 300 is seen with reference to FIG. 8, which illustrates the improved drain spout 100 attached to the rear lower surface of a tank and in operative connection and communication with a drain outlet on the bottom surface of the tank. Because the tank's outer profile comprises a radius R at the point of connection, matching the tank radius with a complementary radius on the flow pipe 300 at radiused transition 304 creates a much tighter fit than that of the non-radiused prior art drain spout. As shown, a pump may be connected operationally with connection base 200.

Proximal flange 400 is provided either as part of the casting whole or alternatively, and less preferably, flange 400 may be separately provided and then welded to the proximal end P of the flow pipe 300. The flange 400 surrounds the radiused proximal end of the flow pipe 300, extending distally a distance at least equal to the length of the pipe's reduced height upper surface 306, terminating proximate the radiused transition 304 on either side of the elongated sump opening 302. The flange 400 facilitates distortion-free welding attachment to the tank, ultimately providing a vastly improved fit for the improved drain spout against the tank as compared with prior art devices.

In some embodiments, upper surface of flange 400 may be coincident with the reduced height upper surface 306 of flow pipe 300, creating a combined flat surface for connection to the tank. In alternate embodiments, upper surface U of flange 400 may be slightly lower than the reduced height upper surface 306 of flow pipe 300, creating a raised ridge 312 along the inner perimeter of the flange 400 as best illustrated in FIG. 3. When present, the raised ridge 312 also assists in welding the improved drain spout to the tank without warping and with improved fit to the tank.

The present invention should not be considered limited to the particular examples described above, but rather should be understood to cover all aspects of the invention. Various modifications, equivalent processes, as well as numerous structures to which the present invention may be applicable will be readily apparent to those of skill in the art to which the present invention is directed upon review of the present specification.

What is claimed is:

1. An improved drain spout for attachment to a tank, the drain spout being a cast and comprising:
a distal base connector having a distal face and a proximal face and having an aperture therethrough; and
a flow pipe extending proximally from the proximal face of the distal base connector, the flow pipe having a proximal end, an external surface and a smooth internal surface having an internal diameter, the flow pipe further comprising an open sump having proximal and distal ends and defined by a reduced upper surface and a radiused transition disposed between the reduced upper surface and the external surface of the flow pipe proximate the distal end of the sump and a radiused cup formed at the proximal end of the sump.

2. The improved drain spout of claim 1, further comprising a flange arranged around the reduced upper surface of the flow pipe.

3. The improved drain spout of claim 2, further comprising the flange and the reduced upper surface of the flow pipe forming a combined flat surface.

4. The improved drain spout of claim 2, further comprising a raised ridge along the inner perimeter of the flange.

5. The improved drain spout of claim 1, the flow pipe comprising an internal diameter that is larger at the aperture of the distal base connector than a proximal internal diameter of the flow pipe.

6. An improved drain spout for attachment to a tank, the drain spout being a cast and comprising:
a distal base connector having a distal face and a proximal face and having an aperture therethrough;
a flow pipe extending proximally from the proximal face of the distal base connector, the flow pipe having a proximal end, an external surface and a smooth internal surface having an internal diameter, the flow pipe further comprising an open sump having proximal and distal ends and defined by a reduced upper surface and a radiused transition disposed between the reduced upper surface and the external surface of the flow pipe proximate the distal end of the sump and a radiused cup formed at the proximal end of the sump; and
a flange arranged around the reduced upper surface of the flow pipe.

7. The improved drain spout of claim 6, further comprising the flange and the reduced upper surface of the flow pipe forming a combined flat surface.

8. The improved drain spout of claim 7, further comprising a raised ridge along the inner perimeter of the flange.

9. The improved drain spout of claim 6, the flow pipe comprising an internal diameter that is larger at the aperture of the distal base connector than a proximal internal diameter of the flow pipe.
